(19) United States
(12) Patent Application Publication
(10) Pub. No.: US 2023/0267390 A1
(43) Pub. Date: Aug. 24, 2023

(54) SYSTEMS AND METHODS FOR OPTIMIZING THE MANAGEMENT OF WORKSITES

(71) Applicant: The Texas A&M University System, College Station, TX (US)

(72) Inventors: Xingyong Song, Cypress, TX (US); Abhishek Paramasivan, Chandler, AZ (US)

(73) Assignee: The Texas A&M University System, College Station, TX (US)

(21) Appl. No.: 18/113,472

(22) Filed: Feb. 23, 2023

Related U.S. Application Data
(60) Provisional application No. 63/313,161, filed on Feb. 23, 2022.

(51) Int. Cl. G06Q 10/0631; G06Q 10/0633

(52) U.S. Cl. CPC G06Q 10/06312; G06Q 10/0633

(57) ABSTRACT

A computer implemented method for managing a worksite includes dividing by a worksite optimizer the worksite into a plurality of separate initial operating regions based on a set of input criteria, determining by the worksite optimizer a process chain to be performed by a plurality of machines located at the worksite, adjusting by the worksite optimizer the plurality of initial operating regions based on the process chain to define a plurality of separate final operating regions, and generating by the worksite optimizer a vehicle sequence for at least some of the machines located at the worksite using the plurality of final operating regions.

### CROSS-REFERENCE TO RELATED APPLICATIONS

This application claims benefit of U.S. provisional patent application Ser. No. 63/313,161 filed Feb. 23, 2022, and entitled “Systems and Methods for Autonomously Optimizing the Management of Worksite Machinery,” which is hereby incorporated herein by reference in its entirety for all purposes.

### STATEMENT REGARDING FEDERALLY SPONSORED RESEARCH OR DEVELOPMENT

Not applicable.

### BACKGROUND

Worksites employ various types of machinery for different purposes including, for example, mining operations and construction operations. As an example, a mining worksite may employ excavators for excavating desired materials, wheel loaders for transporting the excavated materials, crushers for processing the excavated materials to form processed materials, and haul trucks for transporting the processed materials. Conventionally, management of worksite machinery such as the initial placement of the machinery (e.g., excavators, wheel loaders, crushers) at the worksite, guidance regarding how the operation of the various worksite machinery should be sequenced, and other factors are decided manually by an operator of the worksite.

### BRIEF SUMMARY OF THE DISCLOSURE

An embodiment of a computer implemented method for managing a worksite comprises (a) dividing by a worksite optimizer the worksite into a plurality of separate initial operating regions based on a set of input criteria, (b) determining by the worksite optimizer a process chain to be performed by a plurality of machines located at the worksite, (c) adjusting by the worksite optimizer the plurality of initial operating regions based on the process chain to define a plurality of separate final operating regions, and (d) generating by the worksite optimizer a vehicle sequence for at least some of the machines located at the worksite using the plurality of final operating regions. In some embodiments, the set of input criteria comprises a terrain map of the worksite, and a resource map of the worksite. In some embodiments, the method comprises (e) identifying by the worksite optimizer the identity and location of one or more target resources present at the worksite based on the resource map, and the location of drivable regions present at the worksite based on the terrain map. In certain embodiments, (b) comprises temporarily ordering a plurality of separate processes accomplishable by the plurality of machines to produce a finished product of the worksite. In certain embodiments, (c) comprises adjusting the plurality of initial operating regions based on the distribution of target resources present at the worksite. In some embodiments, the method comprises (e) executing by the worksite optimizer the vehicle sequence for at least some of the machines located at the worksite to produce a finished product of the worksite. In some embodiments, (d1) determining by the worksite optimizer both a specific cycle starting position and a specific cycle ending position at the worksite defining a cyclical trajectory therebetween for at least some of the plurality of machines. In some embodiments, (d) further comprises (d2) determining by the worksite optimizer a starting time corresponding to the cycle starting position and an ending time corresponding to the cycle ending position for at least some of the plurality of machines. In certain embodiments, the method further comprises (e) detecting by the worksite optimizer any potential collisions between the plurality of machines in response to executing the vehicle sequence, and (f) adjusting by the worksite optimizer the vehicle sequence in response to detecting at least one potential collision between the plurality of machines in response to executing the vehicle sequence.

An embodiment of a system for managing a worksite comprises a non-transitory memory, and an application stored in the non-transitory memory that, when executed by the processor: divides the worksite into a plurality of separate initial operating regions based on a set of input criteria, determines a process chain to be performed by a plurality of machines located at the worksite, adjusts the plurality of initial operating regions based on the process chain to define a plurality of separate final operating regions, and generates a vehicle sequence for at least some of the machines located at the worksite using the plurality of final operating regions. In some embodiments, the application, when executed by the processor identifies the identity and location of one or more target resources present at the worksite based on a resource map of the worksite, and the location of drivable regions present at the worksite based on a terrain map of the worksite. In some embodiments, the application, when executed by the processor executes the vehicle sequence for at least some of the machines located at the worksite to produce a finished product of the worksite. In certain embodiments, the application, when executed by the processor determines both a specific cycle starting position and a specific cycle ending position at the worksite defining a cyclical trajectory therebetween for at least some of the plurality of machines. In certain embodiments, the application, when executed by the processor determines a starting time corresponding to the cycle starting position and an ending time corresponding to the cycle ending position for at least some of the plurality of machines. In some embodiments, the application, when executed by the processor detects any potential collisions between the plurality of machines in response to executing the vehicle sequence, and adjusts the vehicle sequence in response to detecting at least one potential collision between the plurality of machines in response to executing the vehicle sequence.

An embodiment of an automated worksite system comprises a plurality of machines located at a worksite, each of the plurality of machines comprising a machine controller, a worksite optimizer in signal communication with the machine controllers of the plurality of machines, wherein the worksite optimizer is configured to: divide the worksite into a plurality of separate initial operating regions based on a set of input criteria, determine a process chain to be performed by the plurality of machines located at the worksite, adjust the plurality of initial operating regions based on the process chain to define a plurality of separate final operating regions, generate a vehicle sequence for at least some of the machines located at the worksite using the plurality of final operating regions, and instruct the machine controllers of the plurality of machines to execute the vehicle sequence. In some embodiments, at least one of the plurality of machines is configured to extract target resources present at the worksite and to transport the target resources across the worksite. In some embodiments, the execution of the vehicle sequence produces a finished product of the worksite from the target resources of the worksite. In certain embodiments, the worksite optimizer is configured to identify the identity and location of one or more target resources present at the worksite based on a resource map of the worksite, and the location of drivable regions present at the worksite based on a terrain map of the worksite. In certain embodiments, the worksite optimizer is configured to determine both a specific cycle starting position and a specific cycle ending position at the worksite defining a cyclical trajectory therebetween for at least some of the plurality of machines.

### BRIEF DESCRIPTION OF THE DRAWINGS

For a detailed description of exemplary embodiments of the disclosure, reference will now be made to the accompanying drawings in which:

FIG. 1 is a flowchart illustrating an embodiment of a method for managing a worksite;

FIG. 2 is a block diagram illustrating an embodiment of a computer system;

FIG. 3 is a perspective view of an exemplary terrain map of a worksite;

FIGS. 4 and 5 are perspective views of exemplary annotated maps of a worksite;

FIG. 6 is a flowchart illustrating an embodiment of a process chain;

FIG. 7 is a perspective view of an exemplary optimized map of a worksite;

FIG. 8 is graph 150 illustrating an exemplary vehicle sequence;

FIG. 9 is a schematic view of an embodiment of an automated worksite system;

FIG. 10 is a flowchart illustrating exemplary worksite simulation software; and

FIG. 11 is a diagram illustrating exemplary worksite simulation software.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, conventionally, management of worksite machinery such as the initial placement of the machinery (e.g., excavators, wheel loaders, crushers) at the worksite, guidance regarding how the operation of the various worksite machinery should be sequenced, and other factors are decided manually by an operator of the worksite. While some conventional tools are present to assist in automating the management of worksite machinery, such conventional tools typically provide only generalized guidance. The manual guidance of the operation of the machinery of a worksite may not optimize the operation of the machinery so as to minimize the time required for performing a given operation (e.g., a mining operation, a construction operation, etc.) at the worksite. For example, manual guidance of the operation of the machinery may not optimize the initial placement and/or sequencing of operation of various machinery of the worksite so as to minimize the overall time required for performing a given operation and in-turn minimize the costs associated with performing the operation. Additionally, conventional tools for assisting in the management of worksite machinery do not provide vehicle sequencing information and instead rely on the user to provide such information.

Accordingly, embodiments of systems and methods for managing a worksite are described herein which automate the process of sequencing the operation of the various machinery located at the worksite. For instance, in a embodiment, a worksite optimizer executable on a computer system divides the worksite into a plurality of separate initial operating regions based on a set of input criteria, and determines a process chain to be performed by a plurality of machines located at the worksite. Additionally, the worksite optimizer adjusts the plurality of initial operating regions based on the process chain to define a plurality of separate final operating regions, and generates a vehicle sequence for at least some of the machines located at the worksite using the plurality of final operating regions. In this manner, the worksite optimizer optimizes both the shape and configuration of the different final operating regions located at the worksite. Additionally, the worksite optimizer optimizes the sequencing and routing of the moveable machines located at the worksite so as to maximize a production goal of the worksite that may be user defined.

In addition, embodiments of automated worksite system are described herein that include a plurality of machines located at a worksite, each of the plurality of machines comprising a machine controller, and a worksite optimizer in signal communication with the machine controllers of the plurality of machines. In this manner, the worksite optimizer, in addition to providing optimized vehicle sequencing and routing for the moveable machines present at the worksite, may autonomously control the operation of the moveable machines so as to successfully execute the vehicle sequences generated by the worksite optimizer. By autonomously controlling the moveable machines the worksite optimizer may decrease the number of human personnel that need be present at the worksite, thereby increasing the safety of the operation (e.g., construction operation, mining operation) performed at the worksite.

Referring now to FIG. 1, an embodiment of a method 10 for managing a worksite. Beginning at block 12, method 10 comprises dividing by a worksite optimizer the worksite into a plurality of separate initial operating regions based on a set of input criteria. In at least some embodiments, the worksite optimizer comprises a computer or computing system.

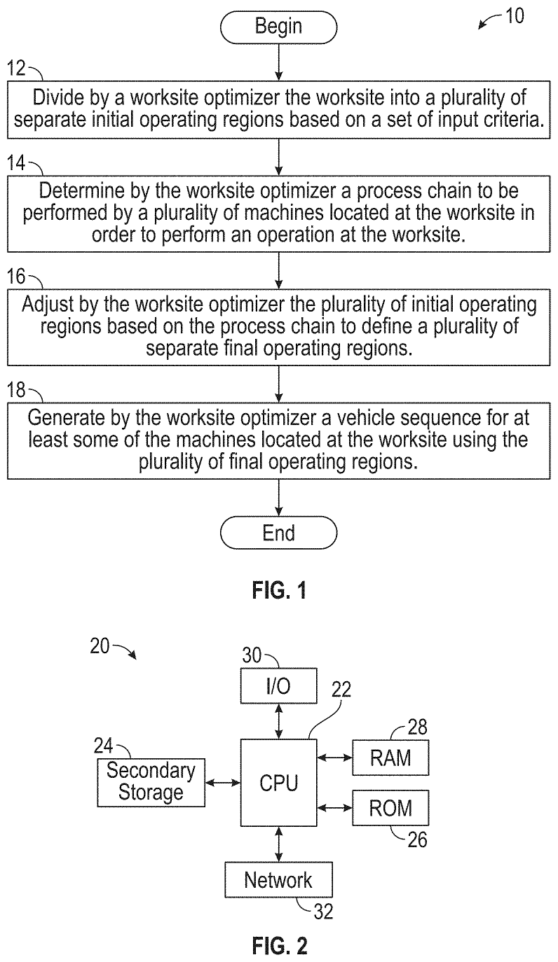

As an example, and referring to FIG. 2, an embodiment of a computer system 20 is shown suitable for implementing one or more embodiments (e.g., method 10 of FIG. 1) disclosed herein. For example, the worksite optimizer of the method 10 of FIG. 1 may comprise the computer system 20 or at least some of the features of computer system 20. The computer system 20 of FIG. 2 includes a processor 22 (which may be referred to as a central processor unit or CPU) that is in communication with memory devices including secondary storage 24, read only memory (ROM) 26, random access memory (RAM) 28, input/output (I/O) devices 30, and network connectivity devices 32. The processor 22 may be implemented as one or more CPU chips. It is understood that by programming and/or loading executable instructions onto the computer system 20, at least one of the CPU 22, the RAM 28, and the ROM 26 are changed, transforming the computer system 20 in part into a particular machine or apparatus having the novel functionality taught by the present disclosure.

Additionally, after the system 20 is turned on or booted, the CPU 22 may execute a computer program or application. For example, the CPU 22 may execute software or firmware stored in the ROM 26 or stored in the RAM 28. In some cases, on boot and/or when the application is initiated, the CPU 22 may copy the application or portions of the application from the secondary storage 24 to the RAM 28 or to memory space within the CPU 22 itself, and the CPU 22 may then execute instructions that the application is comprised of. In some cases, the CPU 22 may copy the application or portions of the application from memory accessed via the network connectivity devices 32 or via the I/O devices 30 to the RAM 28 or to memory space within the CPU 22, and the CPU 22 may then execute instructions that the application is comprised of. During execution, an application may load instructions into the CPU 22, for example load some of the instructions of the application into a cache of the CPU 22. In some contexts, an application that is executed may be said to configure the CPU 22 to do something, e.g., to configure the CPU 22 to perform the function or functions promoted by the subject application. When the CPU 22 is configured in this way by the application, the CPU 22 becomes a specific purpose computer or a specific purpose machine.

Secondary storage 24 may be used to store programs which are loaded into RAM 28 when such programs are selected for execution. The ROM 26 is used to store instructions and perhaps data which are read during program execution. ROM 26 is a non-volatile memory device which typically has a small memory capacity relative to the larger memory capacity of secondary storage 24. The secondary storage 24, the RAM 28, and/or the ROM 26 may be referred to in some contexts as computer readable storage media and/or non-transitory computer readable media. I/O devices 30 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 32 may take the form of modems, modem banks, Ethernet cards, universal serial bus (USB) interface cards, wireless local area network (WLAN) cards, radio transceiver cards, and/or other well-known network devices. The network connectivity devices 32 may provide wired communication links and/or wireless communication links. These network connectivity devices 32 may enable the processor 22 to communicate with the Internet or one or more intranets. With such a network connection, it is contemplated that the processor 22 might receive information from the network, or might output information to the network. Such information, which may include data or instructions to be executed using processor 22 for example, may be received from and outputted to the network, for example, in the form of a computer data baseband signal or signal embodied in a carrier wave.

The processor 22 executes instructions, codes, computer programs, scripts which it accesses from hard disk, floppy disk, optical disk, flash drive, ROM 26, RAM 28, or the network connectivity devices 32. While only one processor 22 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 24, for example, hard drives, floppy disks, optical disks, and/or other device, the ROM 26, and/or the RAM 28 may be referred to in some contexts as non-transitory instructions and/or non-transitory information.

In an embodiment, the computer system 20 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

Referring again to FIG. 1, in some embodiments, the set of input criteria is user defined and comprises an initial terrain map of the worksite, an initial resource map of the worksite, the types and numbers of each type of machine present at the worksite, and a production goal for the operation to be accomplished at the worksite using the machines present at the worksite. For example, the set of input criteria may be provided to the worksite optimizer by I/O devices and/or network connectivity devices (e.g., I/O device 30 and/or network connectivity device 32 of computer system 20 shown in FIG. 2) of the worksite optimizer. It may be additionally understood that the set of input criteria provided above is only exemplary, and in other embodiments the set of input criteria may not include at least some of the input criteria outlined above and/or may include additional input criteria not listed above.

The production goal may vary depending on the particular application. In some embodiments, the production goal specifies one or more material products which an operator of a worksite intends to produce from the worksite, such as Quicklime for a mining worksite. The production goal may also specify the production rates of each specified material product.

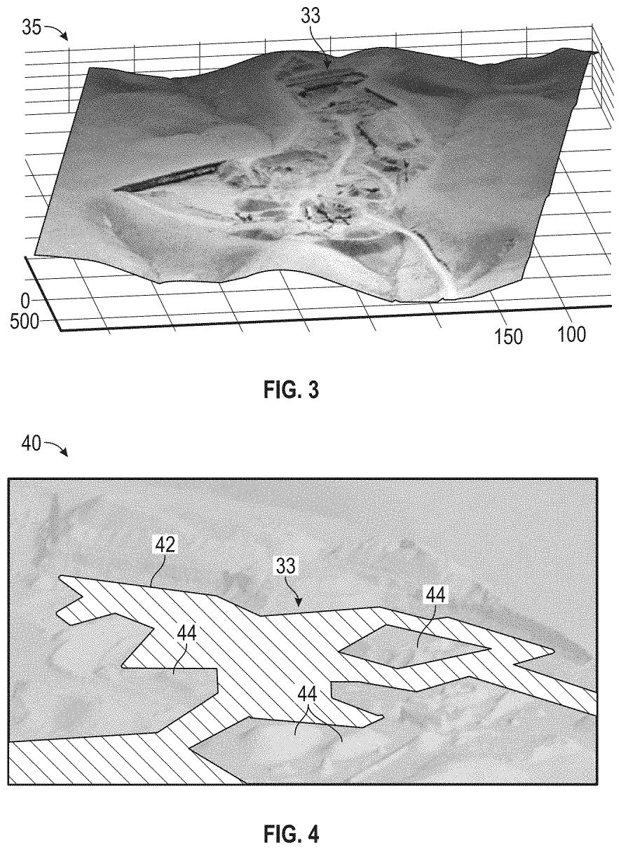

In some embodiments, the initial terrain map of the worksite comprises a three-dimensional (3D) point map. As an example, and referring briefly to FIG. 3, an embodiment of a terrain map 35 of a worksite 33 is shown that comprises, and may thus also be referred to as, a 3D point map 35. 3D point map 35 may be formed through areal surveillance, such as aerial surveillance performed by one or more aerial drones flying over the worksite 33. The point density of 3D point map 35 may vary, with 3D point 35 comprising approximately 100 points per square meter of land in some embodiments.

The resource map identifies the type of soil present at the worksite 33. For example, the resource map may comprise a plurality of resource values identifying the type and quantity of soil present at each (X,Y) point comprising the 3D point map (e.g., 3D point map 35) defining the terrain map. The resource values may comprise scalar values in instances when only a single soil type is present at a given worksite (e.g., A amount of B soil is present at point (X,Y) of the 3D point map), but in instances where multiple soil types are present at the worksite 33 the resource values comprising the resource map may each comprise a matrix identifying the amount of each soil type present at point (X,Y) of the 3D point map.

In some embodiments, the soil types cataloged by the resource map are broken down into accordance with how each soil type or classification impacts the performance of the machines present at the worksite 33. For instance, moveable machines (e.g., wheel loaders, haul trucks) perform differently when travelling on different types of soils. As another example, machines configured to dig into or process soils may perform differently when processing different types of soils. It may be understood that the information comprising the resource map may be combined with the information comprising the terrain map to form a single 3D worksite map providable to the worksite optimizer.

In some embodiments, the worksite optimizer determines the identity and location of one or more target resources present at the worksite based on the resource map, and the location of drivable regions present at the worksite based on the terrain map. For example, and referring briefly to FIG. 4, an embodiment of an annotated map 40 of the worksite 33 is shown. Annotated map 40 may be generated autonomously by the worksite optimizer based on a terrain map and a resource map of the worksite 33 that has been provided to the worksite optimizer. Particularly, annotated map 40 identifies a drivable region 42 of the annotated map 40 over which moveable machines of the machines present at the worksite 33 may travel across. Additionally, annotated map 40 identifies the location of target resources 44 present at the worksite 33.

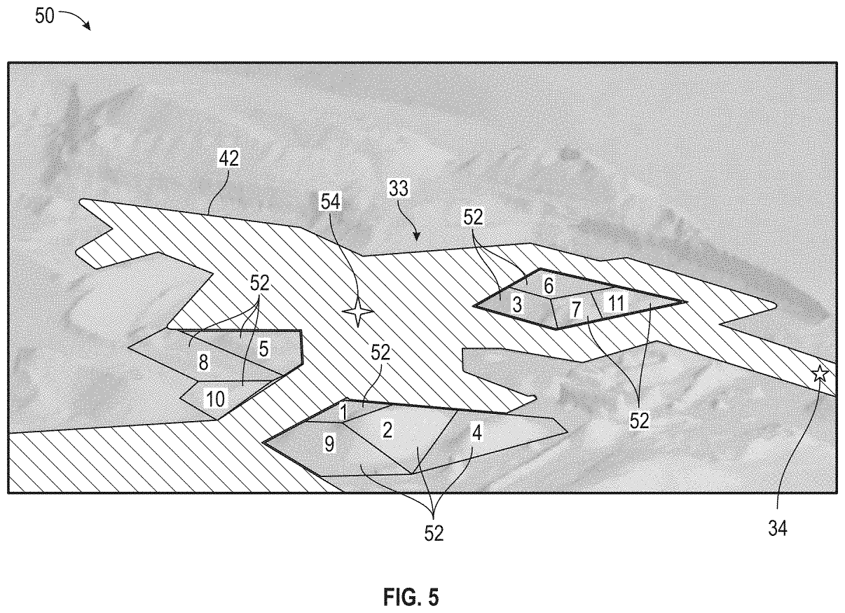

In addition to identifying one or more drivable regions at the worksite, in some embodiments, the worksite optimizer autonomously divides the worksite into multiple separate initial operating regions each containing at least some of the target resources present at the worksite. For example, referring to FIG. 5, in some embodiments, another annotated map 50 of the worksite 33 is generated autonomously by the worksite optimizer identifying (e.g., by the (X,Y) points of the point map 35 from which the annotated map 50 may be based) multiple separate initial operating regions 52 of the worksite 33. The initial operating regions 52 may be shaped by the worksite optimizer to divide the resources present at the worksite 33 relatively evenly between the different initial operating regions 52. In some embodiments, the annotated map 50 comprises a voronoi map generated by the worksite optimizer where the sections of the voronoi map correspond to the initial operating regions 52.

In some embodiments, the worksite optimizer assigns a priority to each of the initial operating regions 52 generated thereby. In this exemplary embodiment, priorities are listed numerically with the initial operating region 52 labeled as “1” in FIG. 5 comprising the highest priority operating region 52 and the operating region 52 labeled as “11” comprising the lowest priority operating region 52. The prioritization of the different operating regions 52 may be conducted based on characteristics of the worksite 33 and of the initial operating regions 52 themselves. For example, the prioritization of the initial operating regions 52 may be based on their proximity to specific machine (e.g., proximity to a crusher for construction applications) present at the worksite 33. Prioritization may also be based on the proximity of the given initial operating region 52 to an entrance 34 of the worksite 33 or with reference to the region's 52 proximity to other features of the worksite 33.

Returning to FIG. 1, at block 14, method 10 comprises determining by the worksite optimizer a process chain to be performed by a plurality of machines located at the worksite in order to perform an operation at the worksite. The determination of the process chain may be performed autonomously by the worksite optimizer using the set of input criteria provided to the worksite optimizer. In some embodiments, the process chain is determined autonomously by the worksite optimizer using the initial operating regions (e.g., initial operating regions 52 of the worksite 33 shown in FIG. 5) of the worksite previously generated by the worksite optimizer.

In some embodiments, the process chain may be generated by the worksite optimizer based on a process lookup table that assigns a specific identity to each of a plurality of processes comprising the process chain, identifies a specific material input and a specific material product for each of the plurality of processes, and determines the type and number of machines of the plurality of machines required to form the material product from the material input each of the plurality of processes. The lookup table may be initially user-defined but may be updated automatically by the worksite optimizer for future applications. An exemplary lookup table pertaining to a mining worksite application is shown below in Table 1.

TABLE 1

| | | | Machines | |
|---|---|---|---|---|
| Product | Process ID | Input | needed | Transportation |
| Mixed rock | 1 | Ground | Excavator | Haul truck |
| 2 inch gravel | 2 | Ground | Excavator, | Wheel loader, |
| | | | wheel loader | haul truck |
| 2 inch gravel | 3 | Mixed Rock | Crusher | Wheel loader, |
| | | | | haul truck |
| 1 inch gravel | 4 | 2 inch gravel | Crusher | Wheel loader, |
| | | | | haul truck |
| Quicklime | 5 | Crushed | Rotary kiln | Haul truck |
| | | limestone | | |

It may be understood that the product of the processes forming the process chain may be a final product produced by the worksite (e.g., Quicklime for a mining worksite) or may be an intermediate product requiring further processing before being formed into the final product. Additionally, the material inputs for the processes forming the process chain may comprise raw materials corresponding to the target resources previously identified by the worksite optimizer, or intermediate products formed by preceding processes of the process chain. In some embodiments, the process chain is captured in the form of a lookup table identifying the identity, product, material input, and the required machines for the given processes.

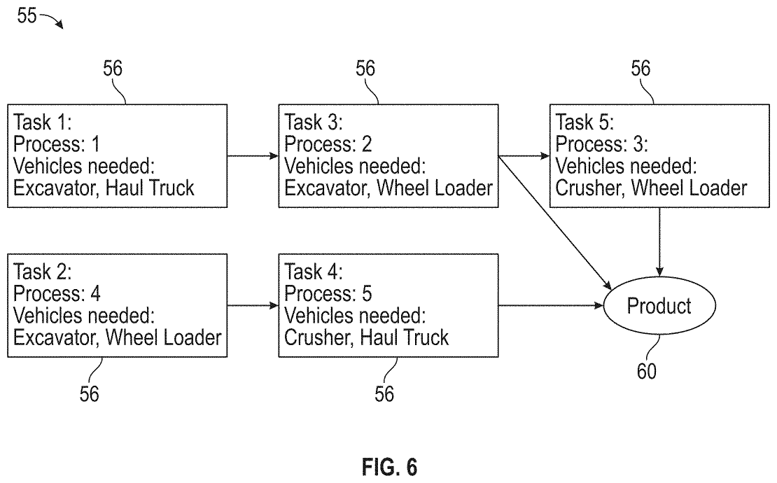

In some embodiments, the worksite optimizer takes the lookup table (which may be user defined in at least some instances) and transforms the information captured in the lookup table into a flowchart defining a temporally arranged order of tasks to be performed where each task corresponds to a process described by the lookup table. As an example, and referring to FIG. 6, an embodiment of a process chain in the form of a flowchart 55 generated autonomously by the worksite optimizer is shown. In this example, the flowchart 55 is based on the information captured in Table 1 above and comprises a plurality of temporally ordered process blocks 56 each describing a specific task linked to one of the processes listed in the lookup table. The performance of the process blocks 56 forming the flowchart 55 results in the creation of the final product 60 in a manner that, in at least some embodiments, maximizes the production goal initially provided to the worksite optimizer as part of the set of input criteria. It may be understood that while in this exemplary embodiment the worksite optimizer generated flowchart 55 from the lookup table shown in Table 1, in other embodiments the worksite optimizer may determine a process chain from information captured in forms other than lookup tables.

In some embodiments, following the determination of the process chain, the worksite optimizer autonomously determines initial location(s) for any stationary machines of the plurality of machines present at the worksite. For instance, in mining worksites, the worksite optimizer may determine the optimal location for one or more crushing machines or crushers present at the worksite. As an example, and referring back to FIG. 5, the annotated map 50 indicates an initial location for a crusher 54 present at the worksite 33. The location of the crusher 54 (or other stationary machinery present at the worksite) may be based by the worksite optimizer on the distance to the site entrance 34 and/or the availability of open, drivable space around the location of the crusher 54.

Returning to FIG. 1, at block 16, method 10 comprises adjusting by the worksite optimizer the plurality of initial operating regions based on the process chain to define a plurality of separate final operating regions. The worksite optimizer may define the final operating regions based on several criteria including, for example, the amount and distribution of target resources in the given operating region, the energy intensiveness of driving through the operating region, the spaciousness of the operating region, the operating region's proximity to other operating regions executing the same task (as defined by the process chain), and/or the operating region's proximity to the operating region handling the preceding or next task in the process chain. Thus, in at least some embodiments, the final operating regions are defined by the worksite optimizer based on the process chain previously determined by the worksite optimizer.

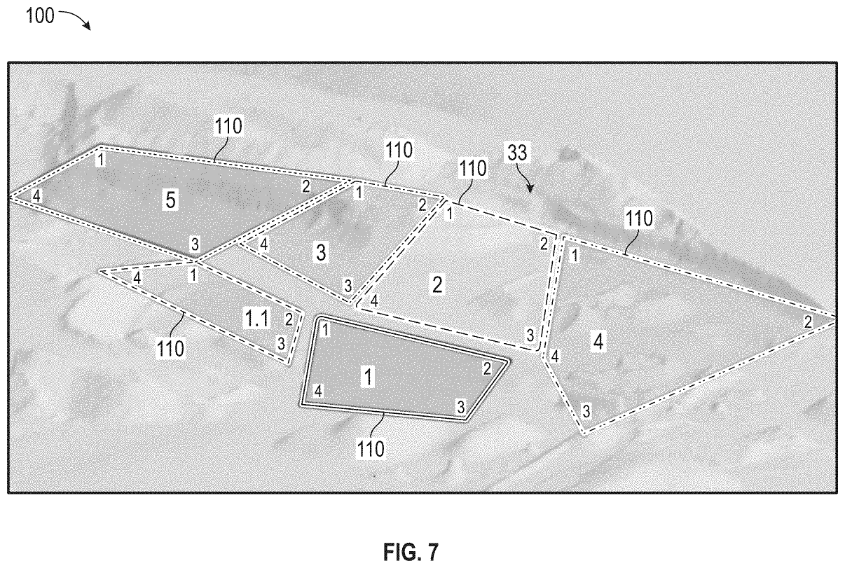

Referring now to FIG. 7, an example of an optimized map 100 of the worksite 33 is shown in which the initial operating regions 52 shown in the annotated map 50 of FIG. 5 have been adjusted and optimized by the worksite optimizer to define a plurality of final operating regions 110 that are different in size and configuration from the initial operating regions 52. In this exemplary embodiment, the final operating regions 110 are prioritized with the final operating region 110 having the highest priority labeled as “1” in FIG. 7 and the final operating region 110 with the lowest priority labeled as “5” in FIG. 7. In some applications, prioritization of the final operating regions 110 is based on proximity to loading bays present at the worksite.

In some embodiments, the worksite optimizer employs an optimization algorithm in adjusting the initial operating regions to define the final operating regions. For example, the worksite optimizer may employ a hybrid method that iteratively applies a particle swam optimization (PSO) algorithm and a steepest ascent algorithm to define the final operating regions. This hybrid approach may be employed to mitigate the risk associated with PSO algorithms of settling on a local maximum rather than the desired global maximum. Additionally, this hybrid approach performs two separate stages of optimization: the first stage utilizes a PSO algorithm to shrink the search domain and to minimize the presence of local maxima, And the second stage of the optimization utilizes a steepest ascent algorithm to determine the maximum of the newly defined domain. It may be understood that in other embodiments, an approach other than the hybrid approach discussed above may be utilized. For example, in other embodiments, a machine learning (ML) approach may be utilized.

At block 18, method 10 comprises generating by the worksite optimizer a vehicle sequence for at least some of the machines located at the worksite using the plurality of final operating regions. With the process chain and final operating regions previously determined by the worksite optimizer, the worksite optimizer may autonomously generate a separate vehicle sequence for each moveable machine located at the worksite based on the process chain and the final operating regions (along with their priority in at least some embodiments). In some embodiments, the vehicle sequence for each moveable machine is cyclical with a given moveable machine travelling repeatedly along a curved trajectory between a starting point and an ending point that is spaced from the starting point. The moveable machine may cycle between the starting and ending points until an end condition is met, such as the exhaustion of a target resource extracted or transported by the moveable machine. In addition to the locations of the starting and ending points for each moveable machine, the worksite optimizer may also generate the curved path extending between the starting and ending points.

In some embodiments, each final operating region is filled with as many machines as possible and a first cycle for each moveable machine is generated by the worksite optimizer and subsequently evaluated by the worksite optimizer. In this manner, each cycle for each moveable machine may be separately evaluated by the worksite optimizer given that the cycles for different moveable machines may terminate at different points in time. Additionally, as described above, the vehicle sequences for the moveable machines generated by the worksite optimizer may be based on the priorities of the different final operating regions. For example, final operating regions having a priority of “2” or greater may be considered by the worksite optimizer to always be active until the target resources located in said regions have been fully exhausted while final operating regions having a priority less than “2” may be considered by the worksite optimizer to be inactive until a material transporter (e.g., a vehicle configured to transport materials to and/or from the worksite) such as a haul truck is en route to the low priority final operating region to be loaded.

In some embodiments, the moveable machines may comprise individual controllers which participate in the planning and/or execution of the vehicle sequence in combination with the worksite optimizer. Alternatively, the worksite optimizer may communicate with and utilize the individual machine controllers in determining the vehicle sequence for each moveable machine located at the worksite. To state in other words, an instance of the worksite optimizer may be executed on the machine controller of the given moveable machine.

As an example, after completing a first cycle, a given moveable machine may check an operating region priority queue generated by the worksite optimizer to determine if there is any final operating region with a lower priority that is currently active and not filled, and if so, will determine if the region requires the specific moveable machine. If the region does require that specific moveable machine, then the moveable machine will determine if there are any identical machines in a region with a higher number and request that the least important moveable machine redirects to fill the non-filled region. This cycle may continue until the required runtime has elapsed or all the target resources have been exhausted. In some embodiments, when a moveable machine is operating only in its own final operating region for multiple cycles, the moveable machine may compute its next cycle starting and ending points as such and, based on the production goal, may work backwards and checks the material amount and location for all the key points in the region.

In some embodiments, the vehicle sequence determined by the worksite optimizer may be presented in tabular or graphical form. Table 2 presented below illustrates an exemplary vehicle sequence in tabular form including cycle starting points, ending points, starting time, ending time, and material stored for a given moveable machine such as, for example, a wheel loader.

TABLE 2

| Starting | Ending | Starting | Ending | Material |
|---|---|---|---|---|
| point | point | time | time | stored |
| (X, Y, θ) | (X, Y, θ) | (min) | (min) | (m\hat{ }3) |
| 27.4, 37.6, 32 | 30.8, 47.9, 92 | 28.83333 | 29.98623 | 2.848 |
| 30.8, 47.9, 92 | 27.4, 37.6, 35 | 29.98623 | 31.02573 | 0 |
| 27.4, 37.6, 35 | 37.8, 55.1, 217 | 31.02573 | 32.43513 | 0 |
| 37.8, 55.1, 217 | 29.4, 58.2, 122 | 32.43513 | 33.14793 | 2.954 |
| 29.4, 58.2, 122 | 38.2, 55.2, 211 | 33.14793 | 33.92283 | 0 |

It may be understood that Table 2 is only exemplary, and in other embodiments the vehicle sequence may not specify the material stored for each cycle for a given moveable machine, such as machines not configured for the transportation of materials or target resources.

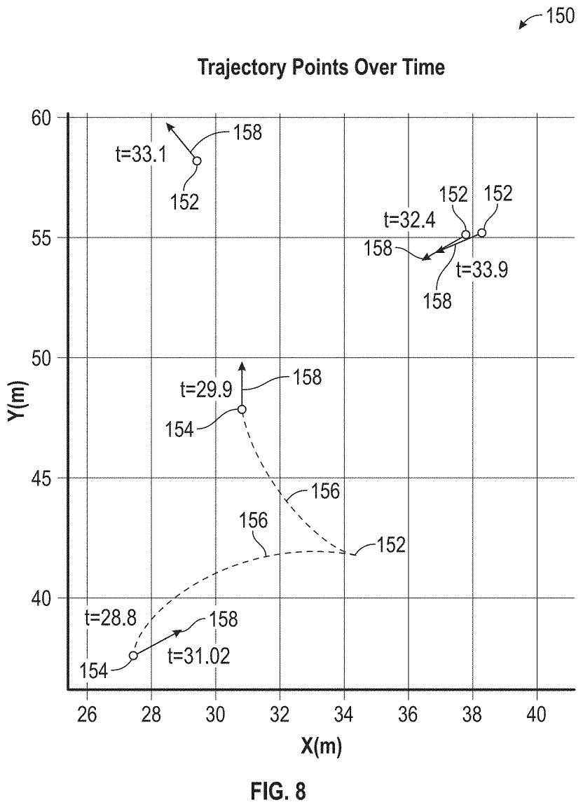

Referring now to FIG. 8, a graph 150 is shown illustrating a graphical representation of an exemplary vehicle sequence determined by the worksite optimizer. Particularly, graph 150 illustrates starting points 152 for different moveable machines plotted against the (X,Y) points of the point map of the worksite. Additionally, graph 150 illustrates ending points 154 for some of the moveable machines along with a curved trajectory 156 extending between corresponding starting and ending points 152 and 154 for the given moveable machine. Further, graph 150 indicates a current orientation 158 of each moveable machine plotted thereon. It may be understood that graph 150 is only exemplary and the vehicle sequence determined by the worksite optimizer may be presented in a variety of forms.

In some embodiments, the worksite optimizer first determines an initial vehicle sequence specifying the respective cycles (e.g., starting point and time, ending point and time) for each moveable machine. Following the determination of the initial vehicle sequence, the worksite optimizer may determine whether any potential collisions may occur between different machines present at the worksite in response to executing the initial vehicle sequence. This may be done by, prior to executing the initial vehicle sequence, determining if any two vehicles occupy the same point in space (e.g., the same or similar (X,Y) points of the point map) at the same point in time. In such an event, the worksite optimizer may autonomously adjust the travelling speed of one of the moveable machines so as to avoid the potential collision, thereby defining a final vehicle sequence for the moveable machines that may vary from the initial vehicle sequence. For example, the worksite optimizer may reduce the speed of a moveable machine having a lower priority so as to avoid the potential collision.

In some embodiments, the vehicle sequence determined by the worksite optimizer is utilized by operators of the worksite as instructions for operating the various machines located at the worksite. In this manner, the vehicle sequence acts as plans to be later executed manually by the operators of the worksite such as the operators or drivers of the moveable machines. Alternatively, in some embodiments, the worksite optimizer itself may autonomously execute the vehicle sequence utilizing onboard controllers of the moveable machines.

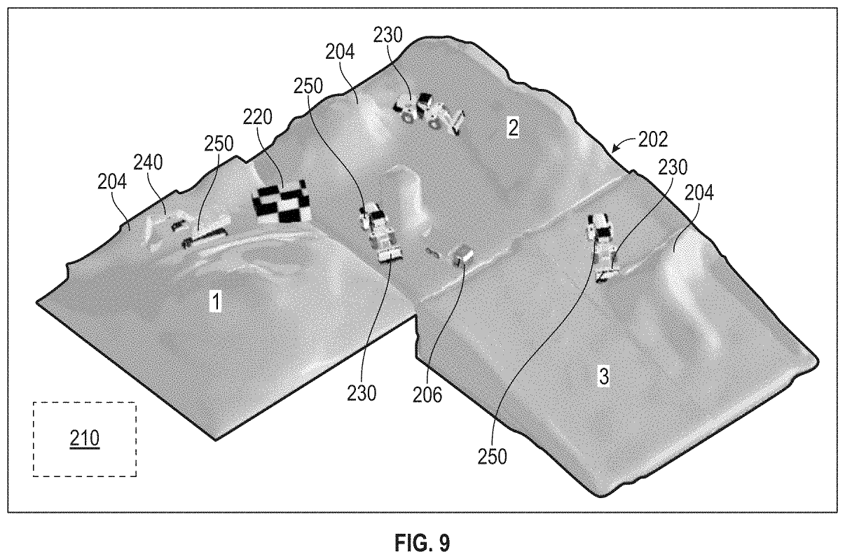

As an example, and referring now to FIG. 9, an embodiment of an automated worksite system 200 is shown that generally includes a worksite optimizer 210, and a plurality of machines 220, 230, and 240 located at a worksite 202 of the automated worksite system 200. In this exemplary embodiment, the worksite optimizer 210 has defined a plurality of final operating regions 215 in which the machines 220, 230, and 240 are located, and has prioritized the final operating regions 215 as indicated in FIG. 9 with the region 215 labeled as “1” in FIG. 9 having the greatest priority and the region 215 labeled as “3” having the lowest priority. The determination of the final operating regions 215 by the worksite optimizer 210 may be performed using a set of input criteria and in accordance with the method steps comprising the method 10 shown in FIG. 1.

In this exemplary embodiment, machine 220 comprises a stationary machine in the form of a crusher and thus may also be referred to herein as crusher 220. Additionally, machines 230, in this exemplary embodiment, comprise moveable machines in the form of wheel loaders configured to extract and transport target resources 204 present at the worksite 202. Further, in this exemplary embodiment, machine 240 comprises another type of moveable machine in the form of a digger also configured to extract and transport target resources 204 present at the worksite 202.

The moveable machines 230 and 240 of automated worksite system 200 each execute a specific vehicle sequence determined by the worksite optimizer 210 in accordance with the method steps of method 10 shown in FIG. 1. Thus, moveable machines 230 and 240 may travel cyclically between opposing starting and ending points in accordance with their specific vehicle sequence. For example, the digger 240 may travel cyclically between a pile of target resources 204 located in its final operating region 215 and the crusher 220 to permit the crusher 220 to process the target resources 204 transported by the digger 240. Additionally, one or more of the wheel loads 230 may travel cyclically between the crusher 220 and a material transporter in the form of a haul truck 206 present at the worksite 202 to deliver finished product processed by the crusher 220 to the haul truck 206 for shipment to a location distal the worksite 202.

In this exemplary embodiment, the moveable machines 230 and 240 are not manually controlled by human drivers. Instead, each moveable machine 230 and 240 comprises an onboard machine controller 250 that is in signal communication (e.g., wireless signal communication) with the worksite optimizer 210. Indeed, in some embodiments, an instance of the worksite optimizer 120 itself may be executed on the machine controllers 250 of the various moveable machines 230 and 240 of the automated worksite system 200. Each machine controller 250 comprises a computer system that may share features in common with the computer system 20 shown in FIG. 2. Additionally, each machine controller 250 controls a powertrain of the moveable machine 230 or 240 to which it is connected to thereby control the position, speed, and orientation of the moveable machine 230 or 240. The machine controller 250 may also operate tools or appurtenances of the given moveable machine 230 or 240 to which it is connected, such as loading bucket or other appliance. Further, each machine controller 250 may also include a sensor package to provide sensor feedback to the worksite optimizer 210 as the moveable machines 230 and 240 execute their respective vehicle sequences as determined by the worksite optimizer 210.

Experiments were conducted pertaining to systems and methods for optimizing the management of worksites. Initially, it may be understood that the following experiments described herein are not intended to limit the scope of this disclosure and the embodiments described above and shown in FIGS. 1-9.

These experimental studies were intended to develop worksite simulation software providing a macro site-level optimization to optimize the time-based sequencing of the connected autonomous vehicles as well as optimizing the starting and ending positions and orientations of vehicle loading cycles. Each starting and ending location was associated with a vehicle orientation and timestamp that can be sent to a vehicle level controller. The vehicle level controller could then function based on the outputs generated by the software. The worksite simulation software was also intended to provide a user-friendly way to generate a set of commands to provide to a fleet of connected autonomous construction vehicles in order to carry out a series of repetitive earthmoving tasks. These are common tasks like loading material into a haul truck, excavating material from a mining site, or performing the grading work for a construction site to name a few.

The worksite simulation software developed as part of these experimental studies required a set of inputs to describe the construction site and the task desired to be performed. These inputs needed to comprise readily available data that does not require a high degree of technical knowledge to understand or use, as the worksite simulation software could eventually be used by site managers or general contractors that may not be very well versed in software. It was thus intended that the software should provide the set of vehicle operating instructions in two ways. First, as a set of trajectory points to send to the vehicles for exact control generation. To ensure minimal time loss and high accuracy, the data sent to the vehicles must be concise and easy to manipulate for the vehicle level controller. Second, the set of vehicle operating instructions were provided as a graphical representation for a human operator to see, verify, and manually modify if necessary. The software inputs provided as part of this experimental study as well as a set of optimization constraints are outlined below:

1. Initial 3D point map of the terrain: The expected point density for the 3D height map was 100 points ±5 per square meter of land. This is lower than current common point map densities and may be increased later if the algorithm for processing and visualizing the worksite is made more efficient.

2. Material distribution map of the terrain: For most sites, the entire site has the same type of soil throughout, in which case this will simply comprise a scalar value, where each soil type will have a corresponding number. For the purposes of soil-wheel interaction, they can be broken into five categories with each category having its own set of properties. While the worksite simulation software did not pertain specifically to vehicle dynamics, the software did pertain to sequencing which is impacted by individual vehicle performance. Based on some initial experiments, using validated wheel loader models and soil-wheel models, it was determined that soil type also plays a significant role in the efficiency of the path and especially for the angular orientation for digging into a material pile. Oftentimes in mining, even for something like gravel and sand, other soil types are mixed near the top layers which interact with the vehicles. Further, the size of the material was also included in the material distribution map. An additional reason for this is that the software optimizations can still hold true in the event of unexpected weather conditions as the weather will impact the soil properties and can cause major safety issues with operating the vehicles. For example, driving a vehicle on muddy terrain compared to dry gravel would significantly impact constraints like how much the vehicle can turn within a certain amount of time.

3. Production goals: This user input specified how many kilograms per hour of each type of material that the user wishes the quarry to export.

4. Types of vehicles and models: In this experimental study, the user inputted what the vehicle models used are for each type of vehicle on the site.

5. Number of vehicles: For example, the user will specify how many wheel loaders and excavators are being used.

### Optimization Constraints

1. Maximum monetary hourly cost: While the goal of the optimization was to minimize the cost, this input was required to ensure that the production goal is feasible. If the production goal cannot be met with the maximum hourly cost then the worksite simulation software can give appropriate feedback to the user rather than giving a harder to understand error or what seems like incorrect optimization results.

2. Length of operation: This optimization constraint pertained to how long it is desired for the task to run.

Additionally, certain vehicle parameters were required pertaining to the mechanical specifications for each vehicle that can be kept in a lookup table or document for the worksite simulation software to refer to rather than the user having to input it for every job. Specific vehicle parameters included: (1) the maximum speed of each vehicle available; (2) minimum turning radius of each vehicle available; (3) tool location, such as where is the tool located on the vehicle relative to the rotation axis of the vehicle; and (4) hourly operating costs for vehicle, including maintenance, average fuel costs, and rental/lease costs and supervisory costs were calculated in vehicle level control.

Further, outputs from the worksite simulation software developed as part of this experimental study included: (1) cycle trajectory staring points including X, Y, and Z starting position for all short loading cycles for every vehicle, and angular starting position relative to global X axis; (2) cycle trajectory staring points including X, Y, and Z ending position for all short loading cycles for every vehicle, and angular ending position relative to global X axis; and (3) materials moved each cycle including how much material, if any, is moved during the cycle. Not all cycles were moving material such as when a vehicle moves from a dumping location to the material source. Additionally, there were times when the full tool volume was not needed at the end goal, such as the final cycle when loading a haul truck or if it was moving a heavier material.

### Worksite Simulation Optimization

Optimization Problem Scope

Due to the complexity of a worksite simulation described above, the optimization and sequencing was performed in multiple steps. Particularly, rather than directly optimizing the sequencing, it was deemed better for the purposes of the experimental study to optimize the restrictions on the sequencing.

When running a worksite with one excavator, one wheel loader, and one crusher, there was no complex optimization or sequencing needed. This was because each machine had a singular constant input and output. There was variation in where their location should be as the machines process more and more material, but relative to each other their cycle starting and ending should be the same. However, this was not a realistic scenario as almost all worksites have multiple vehicles operating at the same time due to scale and the main advantage of connected vehicles is they can more efficiently work with each other to increase productivity. However, the same logic can be applied to maximize the production output and minimize idle time of a worksite.

The worksite was split up into operating regions where the vehicles operate. These operating regions were locked by the number of vehicles that can be in them at any given time and were the constraints for the sequencing described further herein. For a mining operation, each operating region had a maximum of one wheel loader, one wheel loader and one crusher located therein. This does not mean the same wheel loader always needed to be in the region and it does not mean there was always a wheel loader in the region. For the crushers, it does not mean the crusher was only in one region. There can be an amount of overlap between multiple regions where the crushers will rest.

Additionally, this same method can be generalized for other repetitive tasks in mining and construction. Particularly, the task can be broken down into a single input single output type task, where the software checks the distribution of a single product and knows which machines are needed to turn it into another product. In this scope product is defined as anything that is quantified and movable on a worksite. For example, on a mining site, it may be pulling large rock out of the ground and turning it into smaller rock. For a construction site, it can be formulated as taking dirt and changing it to air to clear a worksite, or changing air into concrete if a foundation was being poured. For different tasks, different constraints would need to be applied but the method of splitting the site up into operating regions with a minimal number of vehicles in each would remain the same.

Optimization Variables and Constraints

Before describe the objectives and objective functions related to this experimental study, relevant optimization variables and parameters will be presented first. Not intending to be bound by any particular theory, X₁ in Equation (1) below represents the design variables that correspond to the model number of the vehicles used for the earthmoving task and the number of each of them required:

$${X}_{1} = [ \begin{matrix}{x}_{1} \\ {x}_{2} \\ {x}_{3} \\ {x}_{4} \\ {x}_{5} \\ {x}_{6}\end{matrix} ] = [ \begin{matrix}{( E X )}_{n} \\ {( W L )}_{n} \\ {( C R )}_{n} \\ {( E X )}_{m} \\ {( W L )}_{m} \\ {( C R )}_{m}\end{matrix} ] = [ \begin{matrix}Number of excavators \\ Number of wheel loaders \\ Number of crushers \\ Excavator model number \\ Wheel loader model number \\ Crusher model number\end{matrix} ] \qquad ( 1 )$$

For the purposes of this experimental study, these values were held constant as user inputted parameters instead of variables to simplify the optimization, however, alternatively these can be optimized:

Not intending to be bound by any particular theory, the optimization variable X₂ is shown below in Equation (2):

$${X}_{2} = [ \begin{matrix}{x}_{7} \\ {x}_{8} \\ {x}_{9} \\ {x}_{10} \\ {x}_{11} \\ {x}_{12} \\ {x}_{13} \\ {x}_{14} \\ {x}_{15} \\ {x}_{16}\end{matrix} ] = [ \begin{matrix}{d}_{v 1} … {d}_{v i} \\ n {s}_{v 1} … n {s}_{vi} \\ x {1}_{r 1} … x {1}_{rj} \\ y {1}_{r 1} … y {1}_{rj} \\ x {2}_{r 1} … x {2}_{rj} \\ y {2}_{r 1} … y {2}_{rj} \\ x {3}_{r 1} … x {3}_{rj} \\ y {3}_{r 1} … y {3}_{rj} \\ x {4}_{r 1} … x {4}_{rj} \\ y {4}_{r 1} … y {4}_{rj}\end{matrix} ] = [ \begin{matrix}Path distance \\ Number of segments \\ Region 1 vertex : x coordinate \\ Region 1 vertex : y coordinate \\ Region 2 vertex : x coordinate \\ Region 2 vertex : y coordinate \\ Region 3 vertex : x coordinate \\ Region 3 vertex : y coordinate \\ Region 4 vertex : x coordinate \\ Region 4 vertex : y coordinate\end{matrix} ] \qquad ( 2 )$$

The variables of Equation (2) were chosen so that they can be applicable to multiple types of vehicles and machines such as wheel loaders, excavators, haul trucks, and crushers due to the broad scope of construction and mining. Thus, the variables had to be something that was common for all of these types of machinery. To simplify this constraint, vehicles and stationary machines were separated as this particular worksite simulation particularly focused on path scheduling.

It should be noted that each design variable of Equation (2) comprises a vector where i represents the sum of of wheel loaders and excavators, and j represents the number of excavators. It was determined to make each of the operating regions a quadrilateral for the purposes of this experimental study as the outputs of the regions tended to be near the boundaries and there should be ample operating space around the crushers. Additionally, path distance represents the average path distance between the source material and processor, in this case the crusher, for the path. Variables x₉ to x₁₆ represent the vertices for each of the operating regions.

The above variables were determined taking both of these factors into account. The cycle path distance directly influenced cycle time which was important to minimize to thereby allow more material to be moved per hour. The number of segments refers to the number of clothoid curves used to estimate the trajectories taken by the vehicles during the loading cycles. While the exact path taken by the vehicle may be performed by the vehicle level controller, many optimal short loading cycles taken by a wheel loader can be estimated as a clothoid curve.

On many construction and mining sites, each operator is given an operating region to work within to ensure they can continuously work. However, these regions are often given out at semi-randomly, leading to inefficient cycle times. Additionally, when multiple operators need to use a common resource such as a crusher, a queue can form because one person is not accommodating the work of the others. To avoid this, the remaining eight optimization variables chosen define the vertices of the “operating region” that the vehicles will operate in.

Not intending to be bound by any particular theory, the boundaries and constraints for the optimization variables are shown below in Equation (3). These boundaries and constraints are utilized to avoid any unfeasible solutions and also to speed up the optimization by limiting the scope of available possibilities.

0≤x₇≤lₛ+wₛ

1≤x₈≤4

0≤x₉lₛ

0≤x₁₀≤wₛ

0≤x₁₁≤lₛ

0≤x₁₂≤wₛ

0≤x₁₃≤lₛ

0≤x₁₄≤wₛ

0≤x₁₅≤lₛ

0≤x₁₆≤wₛ (3)

The variables (ws and ls) are defined in Table 3 provided below. The above boundaries of Equation (3) comprise limits for the vertex locations and path properties. Additionally, and not intending to be bound by any particular theory, a pair of inequality constraints expressed in Equations (4) and (5) below were also utilized:

$${A}_{r} \leq 0.2 ( {l}_{s} {w}_{s} ) \leq 3.5 \qquad ( 4 )$$

$$\frac{\sqrt{{( {x}_{13} - {x}_{9} )}^{2} + {( {x}_{14} - {x}_{10} )}^{2}}}{\sqrt{{( {x}_{15} - {x}_{11} )}^{2} + {( {x}_{16} - {x}_{12} )}^{2}}} \leq 3.5 \qquad ( 5 )$$

The first inequality constraint of Equation (4) ensured the area of a single operating region Aᵣ is no more than 20% of the site area. While this value was a placeholder estimate based on manual review, testimony from subject matter experts indicated that a limit is typically used to avoid unnecessary confusion on the worksite. Additionally, this size limitation can help limit the operating intervals of the vehicle level controller. Further, constraint two of Equation (5) ensured that the overall shape of the operating region provided for freedom of vehicle movement. If a region is one long thin strip, for example, only path will be available and even if allows for slightly faster cycling, the overall vehicle efficiency will be lower. The constraint comprised a ratio of the length of the major and minor diagonal of the quadrilateral qualitative experimentation with human driven cars in an off-road area.

TABLE 3

| Name | Variable | Unit |
|---|---|---|
| Fuel cost | C_{f} | $/kg |
| Maximum hourly cost | Cₘ | $/hr |
| Excavator hourly costs | Cₑₓ | $/hr |
| Wheel loader hourly costs | C_{wl} | $/hr |
| Crusher hourly costs | Cₑᵣ | $/hr |
| # of resource piles | nᵣ | — |
| Overlap area | Aₒ | m² |
| Crusher production rate | P_{cr} | tons/hr |
| Excavator production rate | Pₑₓ | tons/hr |
| Wheel loader production rate | P_{wl} | tons/hr |
| Length of site | lₛ | m |
| Width of site | wₛ | m |
| # of resource piles in region | nᵣₚ | — |
| Drivable area in region | A_{d} | m² |
| Total region area | Aᵣ | m² |
| Scaled variance of surface | Sₜ | — |
| height | | |

Optimization Objectives

The goal over the optimization problem used in the worksite simulation software is to minimize the hourly operation cost of a fleet of connected autonomous mining vehicles by changing their operating paths and sequencing while satisfying the given hourly production requirements. Not intending to be bound by any particular theory, the hourly cost may be expressed in accordance with Equation (6) presented below:

Hourly Cost=(Cₑₓx₁)+(C_{wl}x₂)+(C_{cr}x₃) (6)

In an ideal situation the production of the site would also be maximized, but for the purposes of this experimental study, the goal of minimizing the hourly operation cost was of primary focus.

However, directly calculating the results without having to simulate the entire task each iteration is not possible without also first obtaining an inaccurate estimation. Given that the computational cost to compute hourly production was quite high, the objective functions sought to influence the vehicle scheduling policy as that is much quicker to compute. To accomplish this, an indirect method was proposed to optimize operating regions, so the objective of minimizing the hourly cost can be achieved. Not intending to be bound by any particular theory, this was achieved by defining two new cost functions, as expressed in Equations (7)-(14) below.

$${J}_{1} = \frac{100 ( {x}_{1} + {x}_{3} - 1 )}{1 + {\sum }_{k = 1}^{{x}_{1} + {x}_{3}} {( {( ( {n}_{r p} ) )}_{k} - a v g ( ( {n}_{r p} ) ) )}^{2}} \qquad ( 7 )$$

$${J}_{2} = \frac{{E}_{1}}{{E}_{2}} \qquad ( 8 )$$

$${E}_{1} = \frac{{\sum }_{k = 1}^{{x}_{1} + {x}_{3}} {E}_{2} ( k )}{{x}_{1} + {x}_{3}} \qquad ( 9 )$$

$${E}_{2} ( k ) = ( \frac{{a}_{k} ( {x}_{7} , {x}_{8} , … {x}_{16} ) {A}_{{d}_{k}}}{{A}_{{r}_{k}}} ) ( \frac{{β}_{k} ( {x}_{9} , {x}_{10} , … {x}_{16} )}{( 1 - {S}_{T} )} ) \qquad ( 10 )$$

E₃=Σₖ₌₁^{x}^{₁}^{+x}^{₂}(E₂−E₁)²²² (11)

A_{d}=0.5(E₄+E₅) (12)

E₄=(x₉x₁₂+x₁₁x₁₄+x₁₃x₁₆+x₁₅x₁₀) (13)

E₅=(x₁₁x₁₀+x₁₃x₁₂+x₁₃x₁₄x₉+x₁₆) (14)

J₁ and J₂ of Equations (7) and (8) represent the variance of pile/material resources across regions and drivability of the region respectively. The definition of the remaining variables of Equations (7)-(14) can be found in Table 3 above.

Maximizing the function J₁ of Equation (7) minimizes the variance in the number of resource piles per region whereby each region requires a similar amount of time to compete their tasks, which minimizes in-turn the idling time of the vehicles in each region. By “resource piles,” what is referred to is the amount of excavatable material in each operating region. Generally, it is desirable to have each region be similar in size so they take similar times to finish processing. This makes it so that vehicles are not constantly switching between regions and causing more potential complications between sequencing and making unnecessary actions. Even if material piles are on the boundary of two regions, some of the qualitative constraints for the region vertices help to avoid collision by making the region boundaries not touch each other by a safe operating margin.

The second function J₂ of Equation (8) represents the drivability of each region, where drivability measures how easily a given vehicle is able to maneuver in the area. For example, a flatter and more open terrain will be better than a steep one with limited driving space for a wheel loader. E₁ of the J₂ function represents the average region drivability, and E₃ represents variance of the region drivability. A greater J₂ value means that flatter and drivable terrain are evenly distributed among the regions, thus giving way to generate a simpler cycle path for each region. E₂(k) of Equation (10) represents the drivability for a single region. The first term of Equation (10) maximizes the amount of drivable terrain in the region so it can be easily traversed. The second term of Equation (10) represents the inverse of the scaled variance so that the overall term is normalized. These are multiplied by α and β respectively.

In these policy objectives, there are two variables: α and β which represent values between 0 and 1 that are defined by how efficiently the specific vehicle performs in different types of situations. For example, what fuel efficiencies are achieved when going up a 10° inclination compared to peak fuel efficiency. Additionally, a represents how the fuel efficiency holds up while turning in different radii in the region specified by variables x₉ to x₁₆. In this experimental study, three points were computed: fuel efficiency when turning at 10%, 50%, and 100% of the minimum turning radius. A curve was fit from these three points. The α score is dependent on the derivative of this curve and the shape of the region. Variables x₇ and x₈ were used to determine weights from an experimentally determined lookup table. As described above, β represents of how the fuel efficiency holds up when going up slopes. Like a, for the specified region, three points were computed at 0%, 50%, and 100 % of max drivable slope for the vehicle.

Worksite Simulation Construction

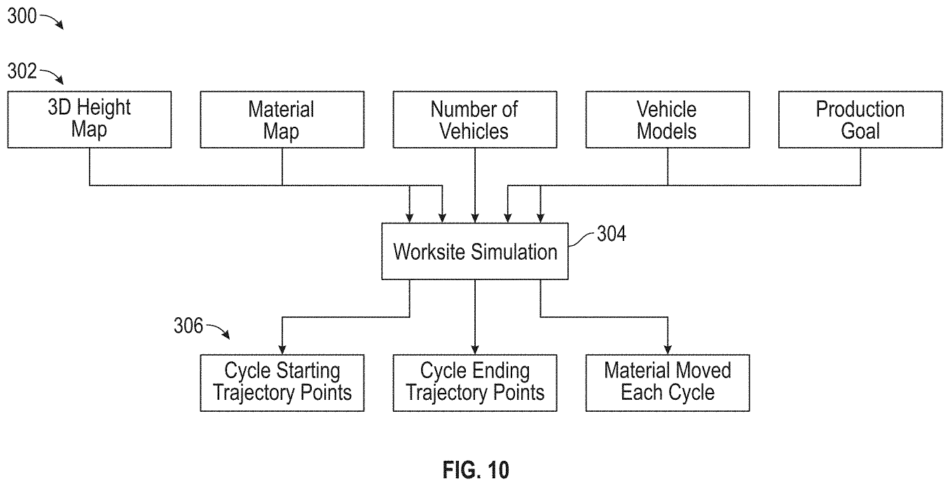

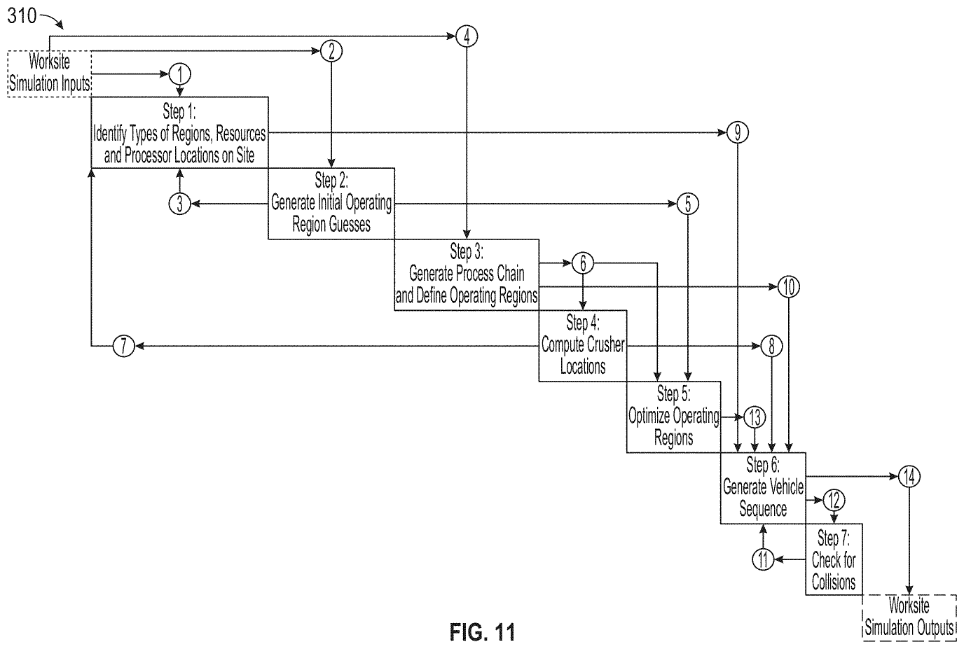

Referring to FIGS. 10 and 11, FIG. 10 illustrates a flowchart 300 representing the worksite simulation software developed as part of this experimental study. Particularly, flowchart 300 illustrates the software inputs 302 supplied to a worksite simulation algorithm 304, and software outputs 306 generated by the algorithm 304 of the worksite simulation software. Additionally, FIG. 11 illustrates a diagram 310 also representing the worksite simulation software developed as part of this experimental study. Particularly, diagram 310 comprises an N² diagram illustrating the logic flow of the worksite simulation software which indicates the type of preprocessing performed to the software inputs 302 of flowchart 300 to make the inputs 302 usable for the optimization algorithm 304.

In the diagram 310 of FIG. 11, (1) represents the 3D point map, and resource distribution; (2) represents resource distribution and location of loading bays; (3) represents resource location priorities which is a value associated with the priority value of each resource; (4) represents source resource(s) and product resource(s); (5) represents resource locations such as where the centroid of each resource pile is located; (6) represents processing procedure including a step by step process for how source resource becomes product resource (e.g., limestone rock becoming fine ground limestone which becomes quicklime); (7) represents crusher locations including (x,y) coordinates for the center of the crusher and the dimensions of the crusher; (8) represents crusher locations; (9) represents resource distribution and location of loading bays; (10) represents the process chain; (11) represents cycle IDs that are interfering; (12) represents all vehicle trajectory points and working material volume; (12) represents optimized operating regions; (13) represents the optimized operating regions; and (14) represents the completed and verified trajectory points for all vehicles.

The first part of the processing task was sorting the site into different regions, and identifying the types of regions on the worksite. There were three main kinds of regions for the purposes of generating the worksite sequence: drivable terrain, raw resources, and non-interactable terrain.

To define drivable terrain, two conditions had to be met: first, the terrain had to have a grade of 10% or less. This requirement was chosen based on required road standards for operating these types of vehicles. For the worksite modeling, any terrain that meets this first criteria was determined as being drivable. The second criteria for operable terrain required that the terrain must be connected to the site entrance by a piece of drivable terrain.

Raw resources are regions of the site where materials can be pulled harvested from. These regions can also be excavated to create a new path so that a more optimal cycle path can be used.

The third type of terrain—non-interactable terrain—represents part of the site that the vehicle cannot modify in any way. Non-interactable terrain comprised existing constructions like gas or water lines underground, worksite administrative or processing buildings, and other forms of non-interactable terrain. These non-intractable terrain elements are not included in the scenarios for this experimental study due to simplicity and ease of visualizing the site with the current methods.

Generation of Initial Operating Regions

This module took all the resource piles on the map and converted them into a separate surface. A weighted voronoi map was then generated for the terrain. These sections of the voronoi map were used for the initial guesses of variables x₉ to x₁₆.

In some instances, the number of operating regions on a site will outnumber the vehicles on the site. Making the total number of operating regions equal to the number of vehicles may thus over constrain the optimization and lead to suboptimal operation regions. Therefore, each section was assigned a priority. The priority of these sections was then assigned by its proximity to the outputs of the input materials in that section. For instance, for the case of the mining operation, it referred to the proximity to the crusher. The top n regions, where n is the number of active regions, was used for the initial guesses for variables x₉ to x₁₆. In longer tasks where the regions needed to be completely redefined, the worksite simulation pulled from the prioritized section list to obtain new guesses during the optimization.

By splitting up the excavatable material into regions with relatively even material distributions, the time required to excavate that single region to be excavated by a single excavator and wheel loader could be estimated. This estimation was used to provide a better initial guess for the worksite planning optimization and sequencing optimization.

Generation of Process Chain

This step of the process instructed the software know how to produce the product material from the source materials. Particularly, this was performed by looking up the product material from a lookup table and working backwards therefrom. The table contained information for how to produce the material, and the type of machines that can move it. An example of this is shown below in Table 4, which was user defined and not generated by the worksite simulation software. However, these look up values can be common between multiple scenarios, so it only required user input during initial software development.

TABLE 4

| Name | Production mode | Production resource | Transport |
|---|---|---|---|
| 2 inch gravel | Ground | N/A | Excavator, wheel |
| | | | loader or haul truck |
| 1 inch gravel | Ground or primary | 1½-2 inch gravel | Excavator, wheel |
| | crusher | | loader or haul truck |
| ½ inch gravel | Primary crusher | ¾-1¼ inch gravel | Wheel loader or |
| | | | haul truck |
| ¾ inch gravel | Secondary crusher | ½-⅞ inch gravel | Wheel loader or hard |
| | | | truck |
| 2 inch crushed | Ground | N/A | Excavator, wheel |
| limestone | | | loader or haul truck |
| Rough ground | Primary crusher | 2 inch crushed | Wheel loader or haul |
| limestone | | limestone | truck |
| Fine ground | Secondary crusher | Rough ground | Wheel loader or haul |
| limestone | | limestone | truck |
| Slaked lime | Plant | Fine ground limestone | Wheel loader |
| Quicklime | Plane | Fine around limestone | Wheel loader |

Computation of Crusher Locations

There were two different modes currently for placing the crusher locations: a first in which a wheel loader takes material from the excavator and loads the material into the crusher, and a second in which the excavator loads material directly into the crusher and a wheel loader is only used on the output. For the purposes of creating a more interesting and complex sequencing problem, the experimental study focused on the first operating mode for the results and optimization.

The location of where to place the crushers were computed based on the optimal cycle time and distances for the wheel loader. Particularly, the crushers were placed in such a way that the wheel loader cycle time for each individual wheel loader travelling to the crusher is close to optimal while minimizing the cycle distance between the crusher output and the haul truck. Additionally, for the second operating mode, the distance between the crusher and excavator was locked between 0.7 and 0.8 times the length of the excavator operating arm adjusted by the excavator moving. In this scenario the generation of the resource piles were adjusted to push the wheel loader cycle time to optimal.

Optimization of Operating Regions

This step solved the optimization problem formulation described above. Specifically, the worksite simulation used a hybrid method of particle swarm optimization (PSO) and steepest ascent to solve the optimization problem. To ensure that the problem does not stumble upon local maxima, which is one of the main downsides of steepest ascent, a three-part system was used to generate the initial guesses, the first part of which is described above. The second part applied a linear transformation to scale the region in the direction of any drivable terrain. The scaling was applied until the area of the region roughly doubled in size. During this step, some of the guesses overlapped which was acceptable as the optimization constraints later addressed these issues. The last step in the process was to use 10-15 iterations of PSO to improve the accuracy of the guesses. A couple advantages were provided by using PSO: the first being that two to three varying initial guesses could be generated for each eventual operating region and run in parallel to determine which initial guess provided the best results. The second advantage was that the PSO implementation had been weighted to quickly shift the guess to the maximum. This method amplified the downside of PSO of overshooting the global maximum, however, it was also proven to provide a guess that was closer to the global maximum than it was to local maximums. Additionally, with the initial guesses for steepest ascent being in the neighborhood of the global maximum, it allowed for the global maximum to be obtained from a simple steepest ascent algorithm.

Generation of Vehicle Sequence

The vehicle sequence was generated for each vehicle based on the operating regions and their priority. Any region with a priority below two was a temporary region and thus was not considered for normal sequence generation. The priority number of the region goes in decreasing order such that the lower the number the more important it is that that region is being worked. These priorities were assigned by proximity to the loading bays. Initially, all the regions are filled with as many excavators, crushers, and wheel loaders as possible. The first cycle for each vehicle was generated on this basis. Additionally, given that each of these cycles may end at different times, each cycle needed to be evaluated individually after every cycle.

Each operating region has certain properties that were determined by the vehicles in it. For example, if a region has one excavator, one wheel loader, and one crusher, it was considered to be filled and active. Any region with a priority of two or greater (e.g., the mining regions) were considered always active until the material was fully exhausted. Loading regions (having a priority of lower than two) were normally considered inactive until a haul truck arrived to be loaded. These regions became active when the haul truck was a certain time away from the site so the rest of the vehicles could prepare. Additionally, when the region was not filled with the required number of vehicles it was considered not filled.

After its first cycle was completed, the vehicle checked the operating region priority queue to determine if there were any regions with a lower priority number that is active and not filled. Additionally, the vehicle determined if the not filled region required that specific vehicle. If it does require that specific vehicle, then the vehicle determines if there are any identical vehicles in a region with a higher number and request that the least important vehicle redirects to fill the non-filled region. This cycle continued until the required runtime was finished or all the source material has been excavated.

For example, in an application where three wheel loaders operate in regions 2-4 with region 1 currently inactive given that there is no haul truck. In this scenario, the software alerted that a haul truck was arriving in five minutes and the wheel loader in region 2 had just completed the end of its cycle. The software then first verified that a wheel loader is needed for the task and then it determined if the wheel loaders in regions 3 and 4 can also perform the task for region 1.

Additionally, in this scenario, all the wheel loaders were identical so the software determined that the wheel loader in region 4 should load the truck when it finished its current cycle. Because all the regions were similar in size and drivable area, the cycle times were also similar to each other (within ˜25%) thus, the method of going from one vehicle to the next for instructions did not cause significant delay.

When a vehicle was just operating in its own region for multiple cycles in a repetitive short loading cycle, the vehicle computed its next cycle starting and ending points as such. Based on the production goal, the vehicle worked backwards and checked the material amount and location for all the key points in the region. For example, how much rock is currently in the crusher or how large is the dumping pile of the excavator. The vehicle then checked the capacity of the machine in the operation region that comes right after itself in the production order. Thus, an excavator would check the capacity/location of its wheel loader and the wheel loader would check the capacity of its crusher. Given that the average cycle time of the region was known, once the crusher was that time away from being able to accept more material, the wheel loader would start to move towards the closest resource pile for the crusher. This could be continuous indefinitely.

Collision Detection

The biggest concern when operating multiple machines in the vicinity of each other is the machines colliding with each other. The software developed as part of this experimental study helped minimize the travel distance and sequenced the wheel loader with the excavator. Additionally, to prevent collisions, for every second the software reviewed the active cycles at that time. This was performed as the sequence was being generated. It created a path between the starting and ending point of the active cycles and drew the shortest path between them based on a modified A-star algorithm to account for orientation. If any of the paths intersected, the software isolated the intersection cycles. Based on the distance along the path where the intersection happened and the cycles' start and end time, the software appropriately delayed the lower priority cycle such that the paths did not intersect.

Sample Cases and Simulation Results

Two sample scenarios analyzed by this experimental study with a specified set of input and parameters will now be discussed.

Scenario 1: Realistic Worksite

Scenario 1 represented a medium size worksite that was a cut section of a real gravel pit with the height map data taken via drone imaging. The scenario was locked to have two wheel loaders with a bucket volume of 3.4 meters cubed (m³), two excavators with a bucket volume of 2.8 m³, and a primary crusher with a capacity of 100 tons per hour (tons/hr) or 80 m³/hr. In this scenario, there was a haul truck that came every 10 to 20 minutes having a capacity of 11 m². The haul truck represented the end of the process chain as it is meant to represent loading to a customer.

While there were two excavators and one loading area, there were only two wheel loaders. This scenario was designed to test the priority system where one wheel loader will switch from its crusher loading task to load the haul truck when needed. The narrow pass to the haul truck, provided a sufficiently challenging sequencing problem given that the wheel loader would pass through another active region to load up the haul truck. Since this was based on actual site data, it also provided a realistic expectation of what to expect on a gravel site.

TABLE 4
Scenario 1 Results

| Quantity | Amount | |
|---|---|---|
| Total cost per hour | 1000 | $/hr |
| Total materials moved | 92 | tons/hr |
| Total approximated expected | 14.35 | gal/hr |
| fuel consumption | | |

Scenario 2: Customized Worksite

For the second scenario it was meant to represent a smaller site. Additionally, the second scenario was fully customized to provide a more complex sequencing and optimization problem. It also provided a site preparation scenario where the goal of the optimization, in addition to being a production goal, was that a certain region of the site should look a certain way at the end. This meant that the region needs to be both excavated and filled in. The algorithm and sequencing for this scenario used open source CNC algorithms and had not been properly optimized or sequenced.

The second scenario was locked with three wheel loaders, one excavator, and one haul truck to represent the customer loading. The three main regions were as such: The first region was the raw material area where the excavator was working. The second region was the processed material area. This area was just filled with stockpiles of product resources ready to be loaded into the haul truck. The third region was the entrance region to be terraformed for another purpose such as building worksite infrastructure. Since this scenario was fully customizable but still somewhat realistic, it provided a good way to stress test the worksite simulation software.

TABLE 5
Scenario 2 Results

| Quantity | Amount | |
|---|---|---|
| Total cost per hour | 700 | $/hr |
| Total materials moved | 58 | tons/hr |
| Total approximated expected | 10.25 | gal/hr |
| fuel consumption | | |

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer implemented method for managing a worksite, the method comprising:
(a) dividing by a worksite optimizer the worksite into a plurality of separate initial operating regions based on a set of input criteria;
(b) determining by the worksite optimizer a process chain to be performed by a plurality of machines located at the worksite;
(c) adjusting by the worksite optimizer the plurality of initial operating regions based on the process chain to define a plurality of separate final operating regions; and
(d) generating by the worksite optimizer a vehicle sequence for at least some of the machines located at the worksite using the plurality of final operating regions.

2. The method of claim 1, wherein the set of input criteria comprises a terrain map of the worksite, and a resource map of the worksite.

3. The method of claim 2, further comprising:
(e) identifying by the worksite optimizer the identity and location of one or more target resources present at the worksite based on the resource map, and the location of drivable regions present at the worksite based on the terrain map.

4. The method of claim 1, wherein (b) comprises temporarily ordering a plurality of separate processes accomplishable by the plurality of machines to produce a finished product of the worksite.

5. The method of claim 1, wherein (c) comprises adjusting the plurality of initial operating regions based on the distribution of target resources present at the worksite.

6. The method of claim 1, further comprising:
(e) executing by the worksite optimizer the vehicle sequence for at least some of the machines located at the worksite to produce a finished product of the worksite.

7. The method of claim 1, wherein (d) comprises:
(d1) determining by the worksite optimizer both a specific cycle starting position and a specific cycle ending position at the worksite defining a cyclical trajectory therebetween for at least some of the plurality of machines.

8. The method of claim 7, wherein (d) further comprises:
(d2) determining by the worksite optimizer a starting time corresponding to the cycle starting position and an ending time corresponding to the cycle ending position for at least some of the plurality of machines.

9. The method of claim 1, further comprising:
(e) detecting by the worksite optimizer any potential collisions between the plurality of machines in response to executing the vehicle sequence; and
(f) adjusting by the worksite optimizer the vehicle sequence in response to detecting at least one potential collision between the plurality of machines in response to executing the vehicle sequence.

10. A system for managing a worksite, the system comprising:
a processor;
a non-transitory memory; and
an application stored in the non-transitory memory that, when executed by the processor: <divides the worksite into a plurality of separate initial operating regions based on a set of input criteria;
determines a process chain to be performed by a plurality of machines located at the worksite;
adjusts the plurality of initial operating regions based on the process chain to define a plurality of separate final operating regions; and
generates a vehicle sequence for at least some of the machines located at the worksite using the plurality of final operating regions.

11. The system of claim 10, wherein the application, when executed by the processor:
identifies the identity and location of one or more target resources present at the worksite based on a resource map of the worksite, and the location of drivable regions present at the worksite based on a terrain map of the worksite.

12. The system of claim 10, wherein the application, when executed by the processor:
executes the vehicle sequence for at least some of the machines located at the worksite to produce a finished product of the worksite.

13. The system of claim 10, wherein the application, when executed by the processor:
determines both a specific cycle starting position and a specific cycle ending position at the worksite defining a cyclical trajectory therebetween for at least some of the plurality of machines.

14. The system of claim 13, wherein the application, when executed by the processor:
determines a starting time corresponding to the cycle starting position and an ending time corresponding to the cycle ending position for at least some of the plurality of machines.

15. The system of claim 13, wherein the application, when executed by the processor:
detects any potential collisions between the plurality of machines in response to executing the vehicle sequence; and
adjusts the vehicle sequence in response to detecting at least one potential collision between the plurality of machines in response to executing the vehicle sequence.

16. An automated worksite system, comprising:
a plurality of machines located at a worksite, each of the plurality of machines comprising a machine controller;
a worksite optimizer in signal communication with the machine controllers of the plurality of machines, wherein the worksite optimizer is configured to:
divide the worksite into a plurality of separate initial operating regions based on a set of input criteria;
determine a process chain to be performed by the plurality of machines located at the worksite;
adjust the plurality of initial operating regions based on the process chain to define a plurality of separate final operating regions;
generate a vehicle sequence for at least some of the machines located at the worksite using the plurality of final operating regions; and
instruct the machine controllers of the plurality of machines to execute the vehicle sequence.

17. The system of claim 16, wherein at least one of the plurality of machines is configured to extract target resources present at the worksite and to transport the target resources across the worksite.

18. The system of claim 17, wherein the execution of the vehicle sequence produces a finished product of the worksite from the target resources of the worksite.

19. The system of claim 16, wherein the worksite optimizer is configured to identify the identity and location of one or more target resources present at the worksite based on a resource map of the worksite, and the location of drivable regions present at the worksite based on a terrain map of the worksite.

20. The system of claim 16, wherein the worksite optimizer is configured to determine both a specific cycle starting position and a specific cycle ending position at the worksite defining a cyclical trajectory therebetween for at least some of the plurality of machines.
